(19) United States
(12) Patent Application Publication
(10) Pub. No.: US 2008/0095465 A1
(43) Pub. Date: Apr. 24, 2008

(54) Image registration system and method

(75) Inventors: Rakesh Mullick, Bangalore (IN); Timothy Poston, Bangalore (IN); Nithin Nagaraj, Bangalore (IN)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/582,645

(22) Filed: Oct. 18, 2006

(51) Int. Cl. G06K 9/36

(52) U.S. Cl. 382/284

(57) ABSTRACT

A moving image is aligned with a fixed image by an initial gross alignment, followed by identification of particular regions or blobs in the moving image. The blobs may be selected based upon particular features in regions of the image, such as anatomical features in a medical image. Blob matching is performed between the selected blobs and the fixed image, and transforms are developed for displacement of the matched blobs. Certain blobs may be dropped from the selection to enhance performance. Individual transformations for individual pixels or voxels in the moving image are then interpolated from the transforms for the blobs.

### BACKGROUND

The present invention relates generally to registration of images. More particularly, the invention relates to techniques for registering one image to another by use of only portions or volumes of interest in each image, followed by the determination of transforms for mapping one image to the other in a deformation field.

Image registration techniques have been developed and are in use in many different fields of technology. In certain registration techniques, which may be termed “fusion”, images are adapted so as to register with one another, and the information defining the images may be combined to produce a composite image. A key step in image registration is to find a spatial transformation such that a chosen similarity metric between two or more images of the same scene achieves its maximum. That is, the most useful alignment or composite image will be produced when similar areas or features of one image are aligned with those of the other.

In a medical diagnostic imaging context, a number of imaging modalities are available. These modalities include, for example, projection X-ray imaging, computed tomography (CT) imaging, magnetic resonance imaging (MRI), positron emission tomography (PET) imaging, single-photon emission tomography (SPECT) imaging, ultrasound imaging, X-ray tomosynthesis, and so forth. Different imaging modalities provide information about different properties of underlying tissues. The images allow clinicians to gather information relating to the size, shape, spatial relationship and other features of anatomical structures and pathologies, if present. Some modalities provide functional information such as blood flow from ultrasound Doppler or glucose metabolism from PET or SPECT imaging, permitting clinicians to study the relationships between anatomy and physiology.

Registration of images from different modalities has become a priority in medical imaging. For example, registration is often extremely useful when comparing images even in the same modality made at different points in time, such as to evaluate progression of a disease or a response to treatment. Still further, registration may be extremely useful when comparing images of a subject to a reference image, such as to map structures or functionalities on to known and well-understood examples.

Most registration algorithms in medical imaging can be classified as either frame-based, point-landmark-based, surface-based or voxel-based (for three dimensional cases). Recently, voxel-based similarity approaches to image registration have attracted significant attention, since these full-volume-based registration algorithms do not rely upon data reduction, require no segmentation, and involve little or no user interaction. Perhaps more importantly, they can be fully automated, and quantitative assessment becomes possible. In particular, voxel-based similarity measures based on joint entropy, mutual information, and normalized mutual information have been shown to align images acquired with different imaging modalities robustly.

Known registration techniques suffer from a number of drawbacks, however. For example, certain techniques may require rigid or affine transformation for a final mapping of an entire image onto another. Other techniques allow for locally adaptive non-parametric transformations, but these tend to be computationally intensive methods such as fluid, diffusion, and curvature-based techniques. Rigid transformations have a significant drawback in that they do not sufficiently adapt to movement of a subject, such as a breathing patient. While locally adaptive techniques may capture local variations, they require landmarks to be defined before registration, making them semi-automatic only. Such techniques are not typically robust in multi-modality settings. Moreover, to the extent that any of these techniques requires full image matching, it tends to be quite computationally costly.

There is a need, therefore, for improved approaches to image registration, particularly ones that can allow for locally adaptive transformations, while providing highly efficient processing from a computational standpoint.

### BRIEF DESCRIPTION

The invention provides a novel approach to image registration designed to respond to such needs. The technique may be applied in a wide range of settings, and is particularly well-suited to image registration in the medical image context, although it is certainly not limited to any particular field of application. The technique may be used in mono-modality image registration, but is particularly powerful in multi-modality applications, and applications for registration of images from single or different modalities taken at different points in time. It may also find use in aligning images of particular subjects with reference images. Moreover, the invention may be used in both two-dimensional and three-dimensional image data registration, as well as four-dimensional applications (including a time component), where desired.

In accordance with certain aspect of the invention, a method for registering images includes selecting candidate subregions in a moving image, the subregions comprising less than an entire image space of the moving image. Some or all of the subregions are then selected from the candidate subregions, and transforms are determined for the selected subregions to similar subregions in a fixed image. The transforms are then interpolated for image data outside the transformed subregions. The transforms may include both rigid and non-rigid transforms for each pixel or voxel in the subregions, and in data of the image not in a subregion.

In accordance with another aspect of the invention, the candidate subregions are sub-selected to reduce the number of matched and transformed subregions. The sub-selection may be performed automatically or based upon operator input, such as to force close registration of important or interesting regions in the image, such as for specific anatomies or pathologies.

### DRAWINGS

These and other features, aspects, and advantages of the present invention will become better understood when the following detailed description is read with reference to the accompanying drawings in which like characters represent like parts throughout the drawings, wherein:

FIG. 1 is a generalized diagram of an exemplary image that is to be registered or mapped with respect to a fixed or reference image applying a transformation technique in accordance with the invention;

FIG. 2 is a detailed view of an exemplary spatial region or ‘blob’ of pixels to be mapped onto a similar blob of a fixed image in accordance with the present technique;

FIG. 3 is a detailed representation of an exemplary volumetric blob having voxels that are to be registered with similar locations in a fixed image;

FIG. 4 is a diagrammatical representation of exemplary components for use in implementation of the registration techniques of the invention;

FIG. 5 is a flow chart illustrating exemplary high-level phases of processing for the registration technique of the invention;

FIG. 6 is a flow chart illustrating exemplary logic in a gross alignment phase of the processing summarized in FIG. 5;

FIG. 7 is a flow chart illustrating exemplary logic for the blob search phase of processing as summarized in FIG. 5;

FIG. 8 is a flow chart illustrating exemplary logic in the blob match phase of processing as summarized in FIG. 5;

FIG. 9 is a flow chart illustrating exemplary logic for an interpolation phase of processing as summarized in FIG. 5;

FIG. 10 is a diagrammatical representation of a two dimensional Delaunay triangulation used in an exemplary embodiment for interpolation of pixel or voxel transformations; and

FIG. 11 is a diagrammatical representation of movement of individual pixel information in a deformation field by virtue of interpolated transformations.

### DETAILED DESCRIPTION

The present invention provides a generic framework for fast and accurate deformable registration of images. Rather than performing elastic transformations which are computationally intensive, or strict rigid transformations on entire images, the technique determines transformations for individual elements of an image, that may be rigid or non-rigid in the same image, both at global and at local levels in volumes of interest (VOIs), called “blobs” in the present discussion. Note that a blob is not necessarily itself a volume of interest, in the sense used for many segmentation and analysis algorithms, such volumes of interest typically being larger, connected parts of an image in which some whole structure may be examined. A blob is typically a smaller region, perhaps within a VOI, in which (for example) a clearly shaped corner of the structure may be perceived. These blobs may be considered as analytical landmarks for other registration schemes, which can be either parametric or non-parametric. The proposed technique involves a global registration followed by local registrations interpolated from pre-computed displacement transformations for the blobs. The initial global matches are performed to correct gross misalignments. (A pyramid-based multi-resolution decomposition at this stage may help to improve the robustness and timing of the global registration.) The step of local registrations involves automatic selection of the blobs, followed by local matching (typically affine/rigid or deformable) and finally interpolating the individual transformations obtained across an entire two-dimensional or three-dimensional image space. Even if deformable methods are used locally, the overall registration is fast considering the data size in the blobs as compared to the original data size.

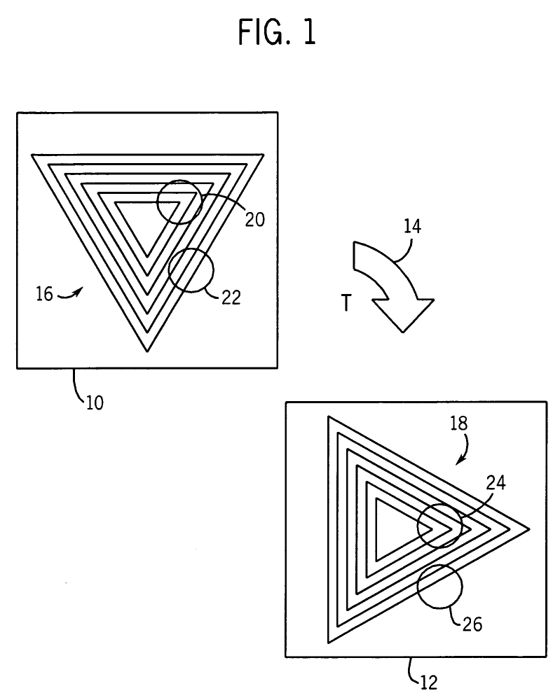

Referring to FIG. 1, a diagrammatical overview of a transformation and mapping application in accordance with the invention is illustrated. The process involves aligning or registering a first image 10 with respect to a second image 12. In the present context, because the first image 10 will undergo transformation, it is referred to as the “moving image”. The second image, to which the moving image will be mapped, will generally be a reference image. It is referred to herein as the “fixed image”. It should be noted that reference will be made in the present discussion to both two-dimensional and three-dimensional image transformation and registration. Although certain of the figures and sections of the discussion will, for the most part, represent and relate to two-dimensional or three-dimensional image transformation only for the sake of convenience, however, it should be borne in mind that the same principles are intended to be applied in the present invention to both two and three-dimensional image manipulation. Similarly, the invention may be applied to images and image sequences in a fourth dimension, including a temporal dimension, although most image registration problems will occur in comparisons of a pair of still images.

The exemplary images represented in FIG. 1 include a series of lines defining triangles, with corners, such lines, triangles and corners being considered as “features”, and corners in particular as “local features”, since they have limited spatial extent. This illustrates that images will by virtue of aspects such as contrast, color, composition and so forth will define features of interest when viewed by a human viewer or when analyzed, such as by computerized techniques. The object of the analysis performed in accordance with the description below is to define a transformation T, as indicated by arrow 14 in FIG. 1, for aligning and registering image 10 with respect to image 12 in as a true a manner as possible. That is, features of interest 16 within image 10 will be altered spatially to closely match similar features 18 within image 12. In a medical diagnostic imaging context, for example, j such features may include anatomies, pathologies, organs and particular tissues, functional areas within the body, and so forth. Moreover, as discussed above, the individual images 10 and 12 may be similar insomuch as they are produced on the same imaging modality system, or they may be produced on different modality imaging systems or devices.

In accordance with the present invention, registration of such images involves computation of transforms at both global and local levels to achieve good accuracy. A piecewise affine registration may be performed which is an approximation to a more refined deformation of the elements of the moving image. The present technique is motivated by the fact that the local subtle variations can be captured with a set of piecewise rigid, piecewise similar, piecewise affine, or piecewise curvilinear transformations within pre-computed analytical landmarks called “blobs”, as indicated at reference numeral 20 and 22 in image 10. It should be noted that, in general, a rigid transformation allows rotation and translation, but takes any pair of points to a pair the same distance of part, and any pair of lines to a pair of lines at the same angle. A similarity transformation takes any pair of lines to a pair of lines at the same angle, but may scale distances. An affine transformation takes the mid-point of any two points to the mid-point of the two points that they go to, and thus takes straight lines to straight lines, but may change both lengths and angles. A curvilinear transformation may bend lines, but is usually required to take them to curves without corners. Such blobs will be identified and matched with similar blobs 24 and 26 in similar regions of the fixed image 12 as described below. The resulting transformation process is less intensive computationally than elastic transformations. Moreover, certain of the blobs may be designated manually, or they may be computed completely automatically, removing the need for intervention by a clinician or technician in designating landmarks.

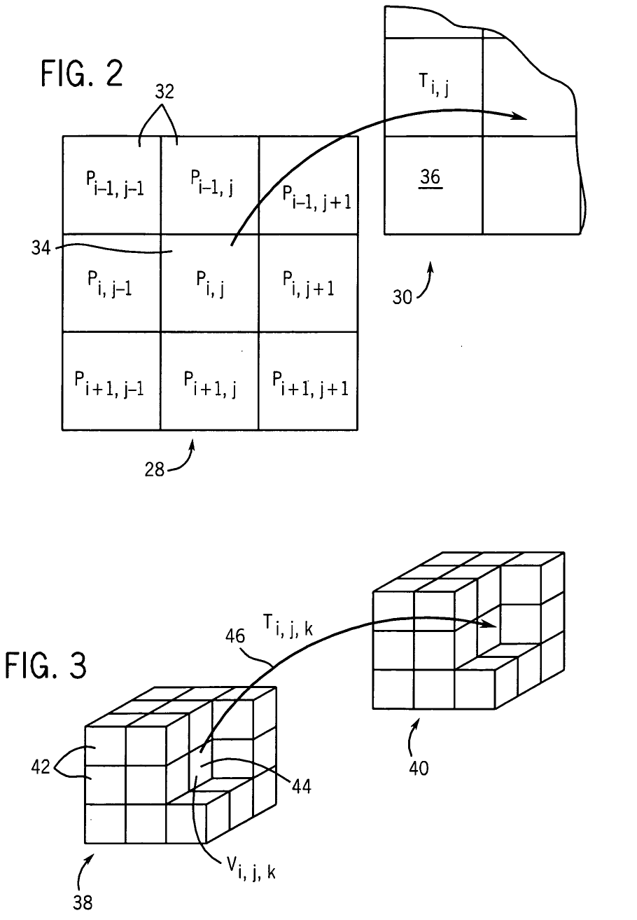

FIG. 2 illustrates, in greater detail, a transformation of the type described below. The transformation will involve, in a two-dimensional image, the mapping of data representative of individual picture elements or pixels in a blob 28 with locations of a similar blob 30 in a fixed image. That is, in a two-dimensional context, each blob 28 will comprise a series of pixels 32, which will generally surround a center pixel 34, denoted P_{i,j}. Following determination of a final transform, each individual pixel 32 will have a separate transform 36, which may be written Q_{i,j}. The final transforms Q_{i,j} of each individual pixel will define a deformation field for recomputing the values of the pixels such that features of interest viewable or detectable in the images are closely aligned or registered with one another. It should be noted, however, that as described below, the present technique enables registrations to be determined with sub-pixel precision, enabling significant improvement in the registration results as compared with heretofore known techniques.

FIG. 3 is a similar representation of the transformation of a volumetric blob in a three-dimensional image dataset. As will be appreciated by those skilled in the art, such three-dimensional images may be made by volumetric imaging techniques, or by associating multiple two-dimensional slice images in a three-dimensional stack. In a manner similar to that discussed with reference to FIG. 2, the blob 38 in FIG. 3 will be matched to a similar region or blob 40 in a fixed image. Each blob comprises a plurality of volume elements or voxels 42, generally surrounding a central voxel 44, which may be designated V_{i,j,k}. The transformation process described below, then, will develop individual transformations 46 for each voxel, as indicated by the nomenclature W_{i,j,k} in FIG. 3.

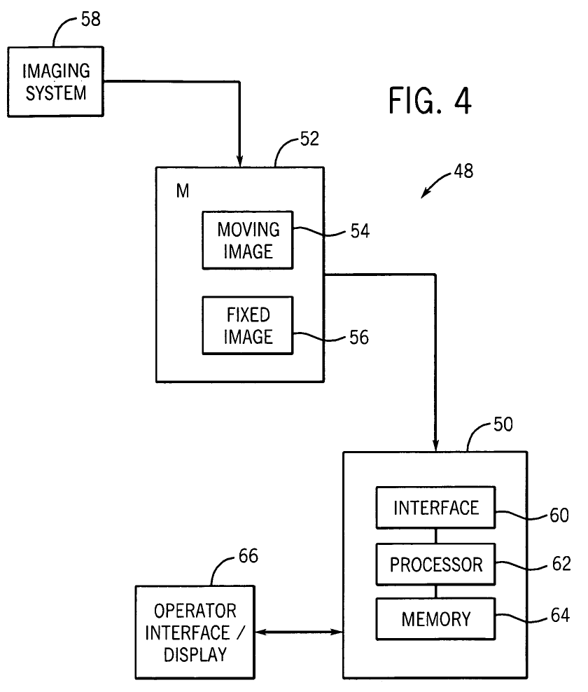

In general, the present technique will be carried out on a programmed computer. The technique may be embodied in software which can be loaded on existing advanced workstations used to process images, such as workstations commercially available under the designation AW (Advanced Workstation) from General Electric Healthcare of Waukesha, Wis. FIG. 4 illustrates certain of the functional components involved in the transformation process.

As shown in FIG. 4, an image processing system 48 will include a programmed computer 50 which is configured to carry out the transformation process described below. In general, the computer will draw images from a storage device 52, which in the medical field may be a picture archiving and communications system (PACS). The PACS 52 will typically store many images in associated sets or series, including the moving image 54 and the fixed image 56. It should be appreciated that the moving image 54 and fixed image 56 may be part of the same or different image sets. Moreover, where a fixed image is a standard reference image, this image may be stored on the computer 50. For images stored in the PACS 52 that have been created by an imaging session with a patient, or other subject, the images will typically be created from data acquired by an imaging system 58. Many different types of imaging systems are known and are currently available, including X-ray, CT, MRI, PET, SPECT, ultrasound, and other systems mentioned above. The images may be produced by any one of these modalities, or indeed by other modalities and devices.

The computer 50 will typically include an interface 60 that communicates with the PACS 52 for retrieving the images to be registered. The interface 60 operates under the control of a processor 62 which also performs the computations for image registration discussed below. In general, any suitable computer, processor, and other circuitry may be used in the performance of the computations. One or more memory devices 64 will be included in the computer 50 for storing both the code executed by processor 62, as well as intermediate and final data resulting from the computations discussed below. In general, in current technologies the memory will include random access memory, read only memory, and cache memory. As discussed below, the present technique has been found to be particularly computationally efficient in the use of cache memory, owing in large part to the analysis and alignment of the blobs discussed above. Finally, the system 48 will include an operator interface and display 66. This operator interface may include any suitable interface devices, such as keyboards, while one or more displays will be included for both interacting with the application performing the transformations, and viewing the initial, pre-processed and processed images.

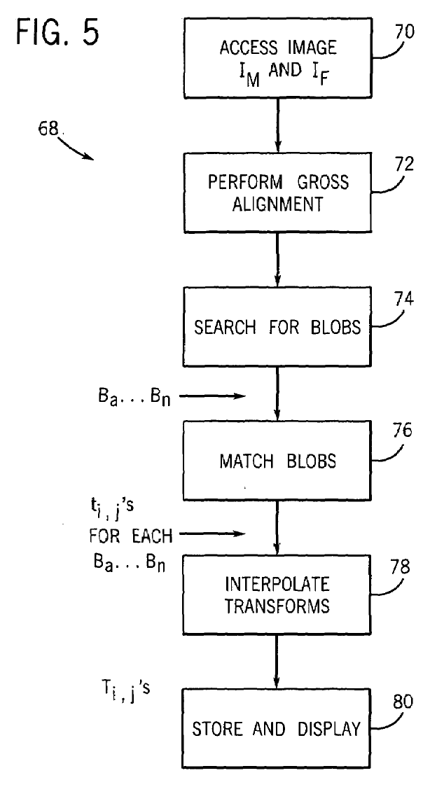

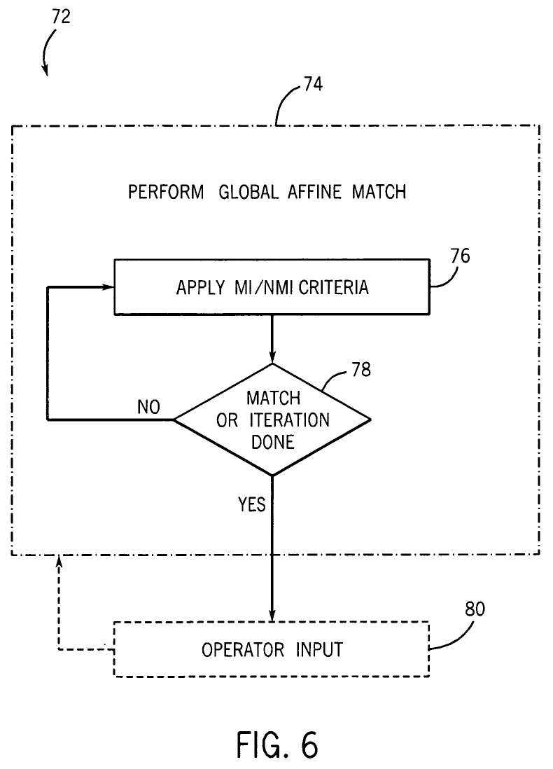

FIG. 5 is a flow chart representing, from a high level, the basic steps or phases in the transformation process in accordance with the present technique. The transformation process begins with accessing the moving image Iₘ and fixed image If from the memory storage device, as indicated at step 70. At step 72, a gross or overall alignment is performed. In a present implementation, this alignment may be based upon an affine registration of the two images by maximizing mutual information in the images, as described below with reference to FIG. 6. Step 72 is intended simply to obtain a macro-scale alignment of the two images. Such alignment will, in general, do away with major misalignment issues, such as, for example alignment of axial with sagittal images in the medical context. That is, the areas or volumes are matched approximately, but in a rigid manner.

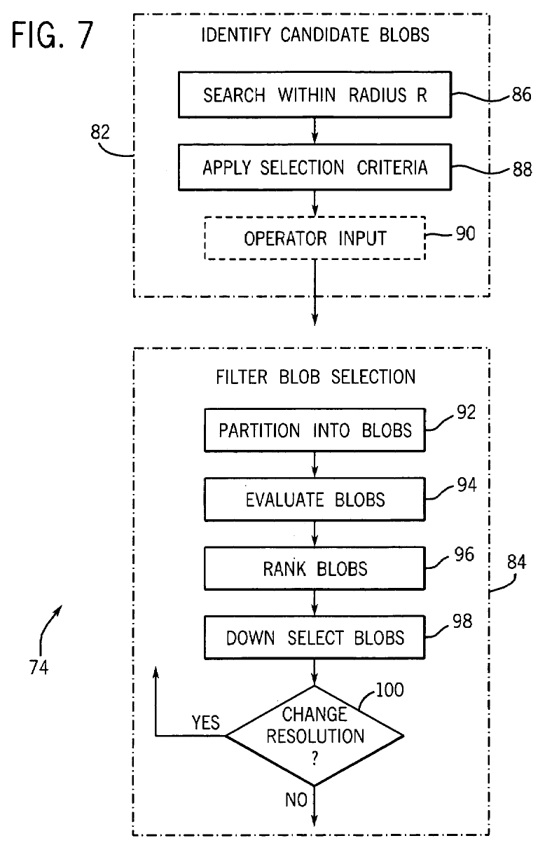

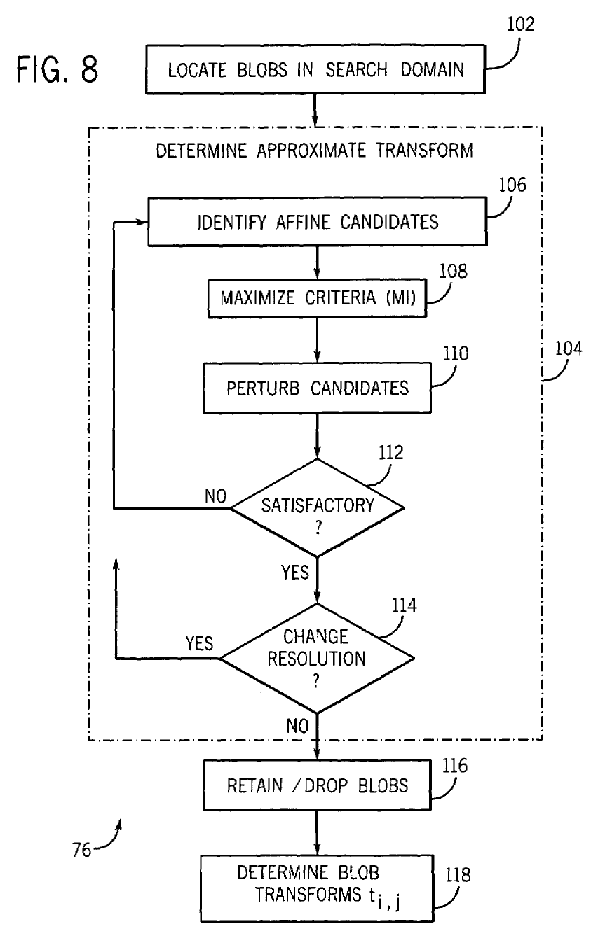

This phase of the process is then followed by a search for blobs or regions in the moving image as indicated by reference numeral 74 in FIG. 5. As described below with reference to FIG. 7, this process may proceed in further phases, such as for manually-assisted or completely automated searches for regions of particular interest analytically in aligning the images. In general, phase 74 of the processing will produce a series of blobs which may be denoted Bₐ to Bₙ. At step or phase 76, then, these blobs in the moving image are matched with similar regions in the fixed image. Again, greater detail will be provided for this phase of the processing with reference to FIG. 8 below. The blob match will then result in individual transforms t_{i,j} for each pixel in two-dimensional blobs, and similar transforms t_{i,j,k} for three-dimensional blobs.

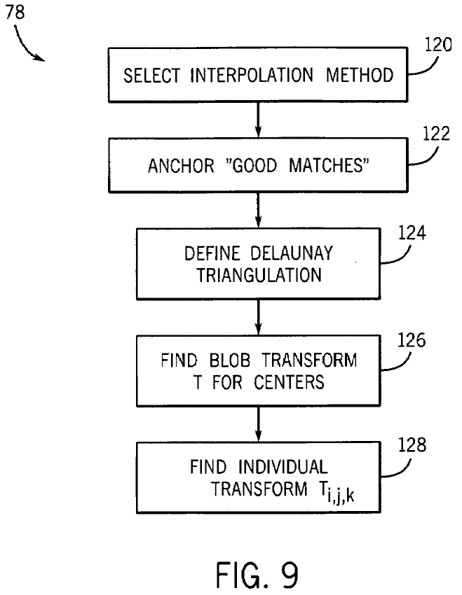

After matching the blobs, the transforms are interpolated as indicated at step or phase 78. Greater detail will be provided regarding this phase of processing with reference to FIG. 9. In general, however, this processing may proceed by establishment of a Delaunay triangulation between blob centers. The ultimate transformations for each individual pixel or voxel will then be determined for the deformation field based upon transformations of the blob centers and pixels or voxels surrounding the blob centers. It should be noted that the final transformations may be rigid or non-rigid. Following the interpolation step, then, the resulting transforms and the resulting manipulated moving image may be stored and displayed as indicated at step 80.

FIG. 6 illustrates exemplary logic for the gross alignment phase 72 of the registration process summarized in FIG. 5. In a presently contemplated embodiment, the process begins with performing a global affine match of the two images, as indicated at step 74. The affine registration of two volumetric images, I_{f} (fixed image) and Iₘ (moving image) involves the registration of Iₘ to I_{f} by determining the best affine transformation T*, which maximizes a given metric, say Φ(.), such that

$${T}^{*} = arg {max}_{T} φ ( {I}_{m} , T ( {I}_{f} ) )$$

$$where$$

$$T = [ \begin{matrix}{a}_{11} & {a}_{12} & {a}_{13} & {x}^{′} \\ {a}_{21} & {a}_{22} & {a}_{23} & {y}^{′} \\ {a}_{31} & {a}_{32} & {a}_{33} & {z}^{′} \\ 0 & 0 & 0 & 1\end{matrix} ]$$

is an affine transformation. In T, the sub-matrix

$$S = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

can be decomposed into shear, scale and rotation and the vector [x′y′z′]^{T} contains the transformations along the three dimensions. The volume T(Iₘ) is the transformed image of Iₘ using the affine transformation T. It is familiar to those skilled in the art that each of shear, scale, rotation and translation is represented with three parameters affecting the three dimensional linear transformation, and that any such transformation can be represented as combinations of these special types, though in the above formula for T only (x′,y′,z′) is a parameter triplet corresponding to one type.

The mutual information (MI) between two discrete random variables U and V corresponding to I_{f} and Iₘ may be defined as

$$\begin{matrix}I ( U ; V ) = {- \sum }_{u ∈ {U}^{′} , υ ∈ {V}^{′}} P ( u , v ) log \frac{P ( u ) P ( v )}{P ( u , v )} \\ = - {\sum }_{i = 1}^{N} {\sum }_{j = 1}^{M} {p}_{ij} log \frac{{p}_{i} {q}_{j}}{{p}_{ij}}\end{matrix}$$

where the random variables U and V take values in the set U′={u₁, u₂, . . . , u_{N}} and V′={v₁, v₂, . . . , v_{M}} with probabilities {p₁, p₂, . . . , p_{N}} and {q₁, q₂, . . . , q_{M}} such that P(U=u₁)=pᵢ, P(V=vᵢ)=qᵢ, pᵢ>0, qᵢ>0 and Σ_{uΕU′}P(u)=1, Σ_{vΕV′}P(v)=1. The quantity P(U,V) is the joint probability of the random variables U and V. MI represents the amount of information that one random variable, here V, contains about the second random variable, here U, and vice-versa. I(U;V) is the measure of shared information or dependents between U and V. It is to be noted that I(U;V)≧0 with equality if, and only if, U and V are independent. MI measures the dependence of the images by determining the distance of their joint distribution pᵢⱼ to the joint distribution in case of complete independence, pᵢqⱼ. Extending from equation 1 above, the best affine transformation T*_{MI}, which maximizes MI defined in equation 4 above is given as

$${T}_{MI}^{*} = arg {max}_{T} I ( {I}_{m} , T ( {I}_{f} ) )$$

As noted in FIG. 6, the present global match or rough alignment of the images may rely upon mutual information or normalize mutual information (NMI) criteria. Many schemes may exist, however, for such alignment, including for affine fits of the images. In a presently contemplated embodiment, a search for a rigid match is not performed, because unlike the collection of rigid matches, the collection of affine transformations is a flat 12-parameter space. Within this space, search is simpler than when confined to its curved 3-parameter subset of rigid motions. The affine search is thus by most methods faster, and provides 6 extras degrees of freedom that allow for a better match, unless there are strong a priori reasons to expect a rigid fit to be possible. Other fits could be implemented as will be appreciated by those skilled in the art, whether rigid, affine or curvilinear, provided that it is sufficient fast and computationally efficient, and reliably provides a fair match. It should be noted that high accuracy at this point is not required.

Following an initial fit at step 76, then, additional iterations may be performed as indicated by decision block 78. That is, depending upon the programming used to implement step 74, several iterations, including iterations at different levels of spatial resolution may be performed for the global match or alignment of the images. Once a sufficient match is found, or a predetermined number of iterations has been performed, processing advances to step 80.

Step 80 is an optional step in which an operator may intervene to provide input regarding the general alignment of the images. As noted above, however, the technique may be implemented in a completely automated fashion, such that user input at this stage may not be required.

Following global alignment of the images, blobs or subsets of the images are identified and processed as summarized in FIG. 7. The blob search phase 74 may be broken down, in a present implementation, to the identification of candidate blobs, as indicated at reference numeral 82, followed by blob selection filtering at a phase 84. In general, a candidate for consideration as a subset or blob may satisfy several criteria, some of which may be dependent upon the nature of the image, the modality, the anatomy viewable in the image, and so forth. For example, as indicated at step 86, in a present implementation a search may be performed through the entire image for all regions having a particular radius R containing what a human viewer would recognize as a landmark. Certain of the requirements or criteria for selection of a region as a blob may not be immediately recognizable by a human viewer, but may be determined by computer analysis. In a present implementation, selection criteria might include a high contrast, rather than a intensity value that is constant or varies gradually across the image. This criterion can be algorithmically embodied in a number of ways. One possible approach is that a histogram of the intensity values in a region should have two or more separate peaks showing the presence of value clusters which are likely to correspond to different types of tissue in the imaged patient. This may be quantified by a measure of entropy of the distribution within the region. This criterion, however, may be supplemented by a spatial organization criterion to avoid selection of regions in which the two-peaked distribution would correspond simply to random mixtures of high and low intensity pixels or voxels without spatial organization. The spatial organization criterion may take the mean position of points of the candidate region, weighted by the intensity values at those points. If this is sufficiently different from the actual center, the spatial structure would impliedly be present.

A further criterion may be an asymmetry criterion. In particular, a high value of mismatch between intensity values at points in a candidate region, versus intensity values at the points found by a rigid or affine transformation applied to them, over all small candidates for such a transformation could provide such a criterion for a good blob.

As noted above, other criteria may be useful in the blob search as well. For example, the criteria may vary with the particular modality used to create the image data. Such other criteria may thus include texture, anatomical or pathological features, blood flow and similar factors as evaluated from PET or SPECT imaging, and so forth.

These criteria are applied at step 88 in FIG. 7 to select a number of candidate blobs. In a present implementation, it is contemplated that no fewer than three such blobs will typically be selected. In our experience it is rare for more than 20 or 30 blobs to be required for an excellent registration. The user may opt to seek more blobs and thus more accuracy, or be satisfied with fewer for greater speed.

As indicated at optional step 90 in FIG. 7, operator input may be received during this process. In particular, where certain regions are known or suspected to be important, an operator may tag such regions for use in the alignment process as blobs. However, again, such input is not necessarily required.

Following identification of candidate blobs, then, a filtering process may be performed both to verify that the blobs should provide for good registration of the images, and to reduce overall computation time required. Thus, at step 92 in FIG. 7, the moving image Iₘ may be partitioned into smaller regions or volumes, these representing blobs. The blob selection performed above may be carried out on such smaller regions. Where such partitioning is performed, each sub-region may then be locally registered in a manner similar to that outlined above. The shape and placement of such sub-regions or blobs will typically govern the accuracy of the deformation field estimation. The sub-regions or blobs may be circular or spherical, as noted above, or may be any other shape, such as cubes, spheroids, parallelepipedic, and so forth. The entire region of the image may be occupied by such sub-regions, or blobs, or reduced portions of the image may be employed. In general, it is considered advantageous to use substantially less than the entire image for this process to enhance computational efficiency. Where the image is initially partitioned into sub-regions in this manner, such partition may be performed in any desired pattern, such as, for volumetric images, hexagonal close packing arrangements, simple cubic packing arrangement, body centered cubic packing arrangements, and so forth (and analogous patterns in two-dimensional images). Again, however, it should be noted that the sub-regions or blobs, may not necessarily be adjacent to one another. Conversely, the sub-regions and blobs may overlap one another, where desired.

At step 94 in FIG. 7, the blobs are evaluated, which may be performed by allocation of a score. Based upon the information content in each blob, a statistical metric (normalized to the blob area or volume) may be calculated. This metric may be correlated with the predicted deformation within each blob. The metric can be the extent of surface mismatches between blobs, the MI value inside the blob, the area or volume overlap of two images in the blob, or any other satisfactory metric. The particular metric employed will likely vary with the application, the type of image being aligned, and so forth.

The blobs may then be ranked as indicated at step 96 in FIG. 7. In this process, the ranking may be based upon the expected level of deformation in descending order. That is, it will be preferable that blobs are selected that do not require extensive deformation, with a rigid fit representing the ideal case. An advantage of step 96 is that it may trade computational time without considerable loss in accuracy, by retaining more critically important blobs. The step is analogous to a manual process wherein with increasing availability of time, the clinical expert would deposit more landmarks (while a skilled operator can define individual landmark pairs in as much as 6 to 10 seconds, the program in the present implementation generated up to 200 landmarks in a volumetric image space measuring 128×128×109 units). This accurately reduces the number of landmarks to be used in a registration step on a cut-off percentage of the metric value, or a number of landmarks to process can be specified.

For example, considering 2 volumes V₁ and V₂, a metric based on the information content in the blobs between these volumes may be computed in accordance with their relationship

M=αvₒ(V₁,V₂)+βg(V₂)

where M is the metric, vₒ(V₁,V₂) is the volume overlap between V₁ and V₂ given as

vₒ(V₁,V₂)=0.5−(DSC(V₁,V₂)mod0.5)

and

$$g ( {V}_{2} ) = \frac{1}{n} {\sum }_{i} \frac{{V}_{2}^{i}}{max ( {V}_{2} )} if {V}_{2}^{i} > g$$

where Vⁱ₂ is the i^{th} voxel's intensity of V₂, max(V₂) is the maximum voxel intensity of V₂ and γ is some threshold. The parameters α and β are weighting factors such that α+β=1, so that 0≦M≦1. DSC(V₁, V₂) is the dice similarity coefficient between V₁ and V₂ defined as

$$DSC ( {V}_{i} , {V}_{2} ) = \frac{2 ( {V}_{1} ⋂ {V}_{2} )}{( {V}_{1} ⋃ {V}_{2} )}$$

As indicated at step 98, then, the blobs can be sub-selected, or reduced in number, to enhance computational efficiency. In a presently contemplated embodiment, significant reduction may be performed based upon the ranking summarized above. Other sub-selection may be performed, for example, based on user input.

In a presently contemplated embodiment, the blob selection process may be performed at more than one resolution, with multiple resolutions being possible in an iterative process, as indicated generally by block 100 in FIG. 7. This may assist in both speed and accuracy. In particular, it may be useful to begin both blob search and blob matching, as described below, with lowered resolution versions of the images involved. Such approaches find an approximate answer faster than a full-resolution approach due to the fewer grid points involved, thus speeding early stages of the search, finally concluding with a higher or maximum resolution. This approach may also reduce the chances for a false match. That is, small blobs could pass a symmetry criterion with motions that are small relative to their size, but could more easily attach to the wrong point in the fixed image where several nearby points may be similar. In a low resolution version, this type of error is less likely given the more gross differences between the lower-resolution pixels or voxels.

Following the blob selection process summarized in FIG. 7, the blobs in the moving image are then matched with similar regions in the fixed image as summarized in FIG. 8. The blob matching process may include a number of steps such as the location of a similar region in the fixed image as indicated at step 102. This location process should be facilitated by the gross alignment performed in accordance with the procedures outlined above. Following location of a similar region in the fixed image, then, in approximate transform is determined as indicated at phase 104 of the processing. The approximate transform determined at phase 104 may begin with identification of affine candidates for transforms of each blob, as such. That is, the implementing routine will locate the best registration for each entire blob selected. It should be noted that affine and other rigid transforms are not necessarily required for this process. Indeed, it may be useful in certain contexts to use non-rigid transforms at step 106. The present technique allows for the use of both rigid and non-rigid transforms in a single registration exercise. That is, for certain tissues in medical imaging, such as bones, rigid candidates, such as affine transforms may be selected. For soft tissues, on the other hand, non-rigid transforms may be used.

Following identification of candidates for transforming each of the blobs, match criteria may be maximized as indicated at step 108. As noted above, such criteria may include mutual information criteria, normalized mutual information, or any other suitable criteria. Further steps may include perturbing the candidates, such as by sliding, rotation, and other small movements which may help to improve the blob-to-blob alignment. At step 112, the routine may determine whether the alignment is satisfactory. If not, an iterative approach may be adopted where additional candidates are identified as potential blob-to-blob transforms. The blob matching routine outlined in FIG. 8 may also involve multi-resolution iterative processing similar to that described above. That is, for speed and accuracy reasons, it may be preferable to begin the transform search with a relatively lower spatial resolution, increasing spatial resolution in several steps to obtain a good rigid or non-rigid fit. If a multi-resolution iterative approach is adopted, the process may return as indicated at step 114 to either identify a different candidate transform, or to refine a selected candidate transform.

At step 116, then, candidate blobs may be retained or dropped. This step is considered particularly attractive in a present implementation insomuch as it may greatly improve the computational efficiency of the search and transformation process, reducing the time required for alignment of the images. The step may be performed automatically, such as in accordance with the processes outlined above for ranking and retention of blobs, or may be performed manually. It should also be noted that as also pointed out above, step 116 may include manual input, such as to force the algorithm to retain certain important or key regions where alignment and comparison are particularly important.

At step 118, then, blob transforms are identified. In general, the blob matching processing primarily establishes one-to-one correspondence between selective blobs in the moving and fixed images. The blob transforms developed at step 118, then, will be based upon the foregoing candidate selection and refinement, and those transforms for retained blobs will be stored. Again, for speed considerations, rigid transforms may be favored, although appropriate cases can call for an overall blob transform which is non-rigid, such as where a blob is in a close proximity to a lesion or other particularly important anatomical feature. Because blobs are typically small compared to the whole image, the usual cost and time objections to curvilinear fitting are much reduced.

Following identification of the blob transforms, then, the interpolation processing summarized in FIG. 9 is performed. Many suitable transformation processes may be envisaged. However, in a present implementation, individual transforms for each pixel or voxel will be derived from the overall blob transforms, with pixels and voxels not located in a selective blob being transformed by interpolation. Essentially, the blob matching the process outlined above results in rigid or non-rigid transforms for each blob center (or a predetermined location or pixel or voxel)in the moving image. Such transforms may be generally considered as linear when considered as mapping a space of vectors based at the blob center to a space of vectors based at a corresponding point in the fixed image. In general, this movement will approximate the global transformation around the blob center. The transformations obtained for each blob will influence a particular region around the blob. Hence, the corresponding transformation of each pixel or voxel will be related to its distance from the blob center (or again, a predetermined location, pixel or vocel) and the nearest blobs. Where particular regions are desired to be “anchored” such that little or no movement is desired (e.g., regions where alignment or correspondence is known to be trustworthy), these particular regions or blobs may strongly influence the movement of other pixels and voxels in their vicinity.

FIG. 9 illustrates the process for interpolation as beginning with selection of an interpolation method at step 120. Several such methods may be employed, such as methods in which a distance from a blob center forms a weighting factor to provide appropriate influence affects on neighboring pixels and voxels. In such approaches, an exponential or 1/radius or 1/radius² or other decay around the center of each blob may be used to define its zone of influence. This approach may ensure that points outside of this region remain unaffected. As noted above, this step may avoid forcing a transformation for an already well-transformed point or region. Other interpolation methods may include nearest-neighbor, bilinear, bi-cubic, quadratic splines, cubic B-splines, Catmull-Rom cardinal splines, higher order B-splines, Gaussians and truncated sinc based interpolation methods. One may also use a tri-linear interpolation of the transformation represented as a quaternion location, based on the transform in the blob-neighborhood. At each pixel or voxel the identity of the belonging blob is determined. Next, the transform at all neighboring blobs (determined by a choice of neighborhood, 4-neighbor, 8-neighbor, 26-neighbor or other) is determined. Then, based on a tri-linear interpolation scheme, the transform at the pixel or voxel is determined by inverse-distance weighting of the translation, scaling, skew, and rotation (using a versor or quaternion representation). Alternately, one may selectively choose from among translation, scaling, skew, and rotation the transform parameters to interpolate, to trade-off for any time-constraints.

At step 122, as noted above, certain areas may be anchored, particularly those that are considered to be well-transformed. A well-transformed point or region may be defined as a point or region which has obtained a convincing transformation after the global registration or the blob matching process outlined above.

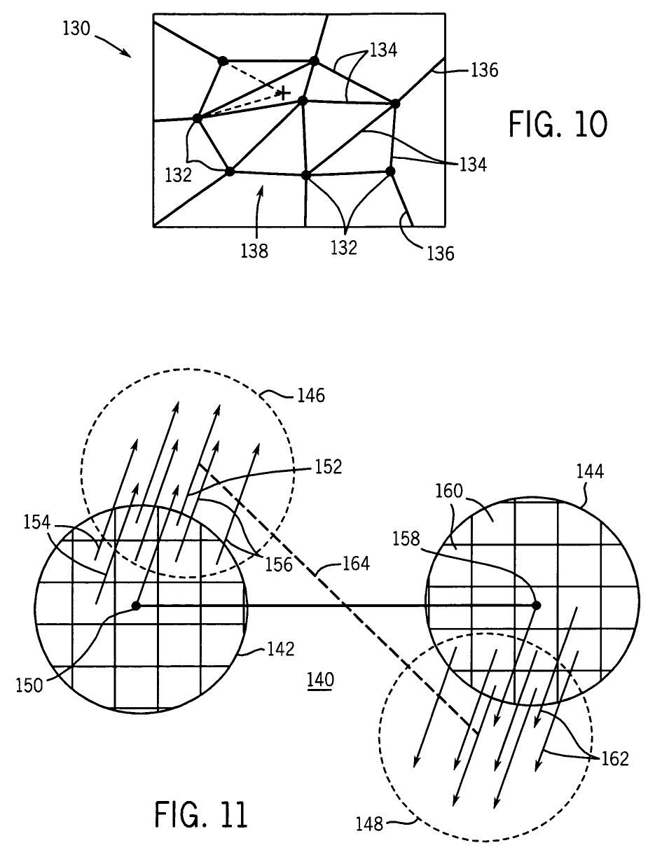

In a presently contemplated embodiment, the interpolation process may construct a Delaunay triangulation for computation of the individual transforms for pixels and voxels. A simplified representation of a Delaunay triangulation is represented generally in FIG. 10, and designated generally by reference numeral 130. As noted above, any method of interpolating between matched landmarks that is known to those skilled in the art may be used at this point. However, the process above extracts more information than other methods in use. As noted above, around each blob center in the moving image an affine transformation is determined, linear when considered as mapping a space of vectors based at the center to a space of vectors based at the corresponding point in the static image. This approximates the global transformation around the center. For any differentiable transformation, its derivative (specified by its Jacobian matrix) at any point is precisely the best linear fit to the transformation near that point (where “near” is made precise taking limits, or invoking explicit infinitesimals). A transformation is thus sought that has (or approximately has) these transformations as derivatives at these points. In an exemplary interpolation method described below, that delivers them exactly, the present invention may include the use of fitting methods that trade off some exactness in agreement against additional smoothness or other desirable characteristics, the construction of which is within the purview of those skilled in the art.

In the example illustrated in FIG. 10, the moving image 130 is divided into a mesh such as a Delaunay triangulation, with vertices 132 at the blob centers. For simplicity of exposition, a two-dimensional example is shown in FIG. 10. Edges 134 are established between these vertices to again divide the moving image into regions. In one method, extra edges 136 pointing to infinity from each exterior corner of the resulting convex hull 138 are defined. Such additional edges may point radially away from a single point inside the convex hull, such as its centroid, or may be constructed by a more local criterion such as pointing in a direction that bisects the greater-than-180° external angle.

If three outer centers pᵢ, pⱼ and pₖ are any three vertices given in order around the hull, the direction of the bisecting line from pᵢ is given by the vector

$$\vec{v} = \frac{{p}_{j} - {p}_{i}}{‖ {p}_{j} - {p}_{i} ‖} + \frac{{q}_{j} - {q}_{i}}{‖ {q}_{j} - {q}_{i} ‖} .$$

Corresponding to this is automatically a triangulation (not necessarily the Delaunay one) of the fixed image, with edges between corresponding pairs of vertices. The line to infinity from an outer point qᵢ is not given by bisecting angles, but by letting the affine transform

$${A}_{i} = [ \begin{matrix}a & c & e \\ b & d & f \\ 0 & 0 & 1\end{matrix} ]$$

act on the direction from pᵢ. Thus we take the above vector \vec{v}=(u, v) in the direction of the bisecting line from pᵢ, and draw a line in the direction

$$[ \begin{matrix}a & c \\ b & d\end{matrix} ] [ \begin{matrix}u \\ v\end{matrix} ]$$

from qᵢ.

Given a general point (x, y) in the moving image, the global transformation value T(x,y) may be computed. The first step is to decide to which triangle it belongs. A point (x,y) that is inside the triangle with vertices pᵢ=(xᵢ,yᵢ), pⱼ=(xⱼ,yⱼ) and pₖ=(xₖ,yₖ) can be written in a unique way as a weighted sum of the three corner coordinates,

$$[ \begin{matrix}x \\ y\end{matrix} ] = {t}_{i} [ \begin{matrix}{x}_{i} \\ {y}_{i}\end{matrix} ] + {t}_{j} [ \begin{matrix}{x}_{j} \\ {y}_{j}\end{matrix} ] + {t}_{k} [ \begin{matrix}{x}_{k} \\ {y}_{k}\end{matrix} ] + {t}_{i} [ \begin{matrix}{x}_{i} \\ {y}_{i}\end{matrix} ] + {t}_{j} [ \begin{matrix}{x}_{i} \\ {y}_{i}\end{matrix} ] + ( 1 - {t}_{i} - {t}_{j} ) [ \begin{matrix}{x}_{k} \\ {y}_{k}\end{matrix} ]$$

with all three weights (found by a matrix multiplication) positive and summing to 1. If it is outside the triangle, the difference is that two or one of the weights are negative, although they cannot all be so.

The corresponding calculations for external “triangles” with a corner at infinity are somewhat different. With points on the boundary of the convex hull of the vertices, outward lines 136 will meet at a “virtual” point and generally not at one of the original blob centers. Linear coordinates tᵢ and tⱼ may thus be defined, that are zero on the lines, and define

$${\tilde{t}}_{i} = \frac{{t}_{i}}{{t}_{i} + {t}_{j}} {\tilde{t}}_{j} = \frac{{t}_{j}}{{t}_{i} + {t}_{j}}$$

which vanish on the same lines, and each equal 1 on others. If the point

$$[ \begin{matrix}x \\ y\end{matrix} ] = {t}_{i} [ \begin{matrix}{x}_{i} \\ {y}_{i}\end{matrix} ] + {t}_{j} [ \begin{matrix}{x}_{j} \\ {y}_{j}\end{matrix} ] + {t}_{k} [ \begin{matrix}{x}_{k} \\ {y}_{k}\end{matrix} ]$$

is inside an inner triangle (i, j, k), a piecewise linear mapping using this mesh carries it to

tᵢqᵢ+tⱼqⱼ+tₖqₖ

This is one method of interpolating between the matched points, and has the merit that the correspondence is easily computed between matched triangles in either direction. Most interpolation schemes produce mappings with an explicit formula in one direction, but a time-consuming non-linear solution process in the other, with no explicit solution formula.

In the approach described above, more information is available than merely where the vertices are located. That is, the affine transformations Aᵢ, Aⱼ and Aₖ associated with the triangle corners are known. Moreover, the value σ(x)=3x²−2x³ may be defined, and the transform T set by the relationship:

$$T [ \begin{matrix}x \\ y\end{matrix} ] = \frac{σ ( {t}_{i} ) {A}_{i} + σ ( {t}_{j} ) {A}_{j} + σ ( {t}_{k} ) {A}_{k}}{σ ( {t}_{i} ) + σ ( {t}_{j} ) + σ ( {t}_{k} )} [ \begin{matrix}x \\ y\end{matrix} ]$$

For (x,y) in an outer triangle, this transform may be defined:

$$T [ \begin{matrix}x \\ y\end{matrix} ] = ( σ ( {\tilde{t}}_{i} ) {A}_{i} + σ ( {\tilde{t}}_{j} ) {A}_{j} ) [ \begin{matrix}x \\ y\end{matrix} ]$$

These expressions give agreement in value and derivative along the shared edges of triangles, and are dominated near a vertex by the desired local transformation at that vertex, giving it as a derivative there. Note that the triangles (or in three-dimensional image processing, tetrahedra), that define the transforms are mapped to regions with (in general) curved boundaries.

The generalization to the three-dimensional case may involve certain intricacies. Like the two-dimensional version, the standard three-dimensional Delaunay triangulation delivers a triangulation or “tetrahedralization” of the convex hull into regions defined by linear inequalities, easily tested. It is useful to extend this property to external regions. The analogue of FIG. 10 would place lines outward from vertices, as edges of unbounded truncated pyramids. A tip face of each pyramid would be an external triangle of the convex hull. However, this may require lines from neighboring vertices to be coplanar, and all three unbounded edges to meet (when prolonged) in a shared point. Vertices shared by neighboring triangles require this to be a single common point for all of these edges. For an elongated convex hull, the resulting external regions are bounded by planes at widely varying angles. The three-dimensional analogue of the latter formula above can be used to define a smooth transformation, but extends the influence of the local transformation found at one corner to regions that could be better dominated by the transformation at a neighboring corner. This may not, therefore, be the most favorable approach.

Mapping each edge to a direction given by a locally chosen affine mapping need not preserve the coplanarity of outward edges from neighboring corners. Therefore, in a presently contemplated approach, piecewise linear attachment of a single external region for each exterior triangle of the convex hull is not performed, as in the two-dimensional approach outlined above.

Rather than lines to infinity from the external corners, outward vectors found radially by averaging normals, or by other convenient means, may be developed to add points outside the boundary of the moving image. A new Delaunay triangulation may then be made, including these points, whose triangles cover the full image. The new points outside the moving image cannot have local matches, so to define a point corresponding to such a point in the static image an affine transformation may be used for each point from which the new point was extended. This provides a corresponding triangulated mesh, which may be used either for piecewise linear matching or smoothed matching using the relationships outlined above.

The foregoing process, then, allows for the determination of transforms at the blob centers 132. This step is generally summarized by reference numeral 126 in FIG. 9. The individual transform of each pixel or voxel is then identified for the entire image or deformation field, as indicated by step 128. FIG. 11 generally illustrates a simplified view of two displaced blobs in a two-dimensional context. The deformation field, designated generally by reference numeral 140 is the space in which the moving image is deformed by the individual transformations of the pixels or voxels. In the illustration of FIG. 11, then, two blobs 142 and 144 will be displaced to locations generally corresponding to those illustrated in dash lines 146 and 148, respectively. A center pixel of blob 142 will generally be displaced in accordance with the overall blob transform T determined in accordance with the procedures described above, as represented generally by reference numeral 152. Other pixels 154 surrounding this center pixel will be displaced along displacement vectors 156 corresponding to their individual transformations. Again, it should be noted that any one of the displacement vectors may correspond to a rigid or non-rigid transform. An advantage of the present technique, for example, resides in the ability to rigidly transform certain pixels, voxels or regions, such as for certain tissues known typically to move in relatively rigid ways, while other pixels, voxels and regions can be displaced in a non-rigid manner.

Blob 144 will be displaced similarly, with a center pixel or voxel 158 being moved by its individual transform, while surrounding pixels or voxels 160 are displaced by their individual displacement vectors 162. Pixels and voxels between blobs 142 and 144 may be displaced in manners that are individualized for each pixel or voxel, and are computed based upon the displacements of the pixels and the blobs, as indicated generally by the connecting line 164 in FIG. 11.

In general, the process outlined in FIG. 9 identifies a native transform for each blob. Each blob will have a composite transform which will generally comprise a best regional match for its displacement. In a present implementation, the center pixel or voxel maintains this native transform, while other pixels or voxels obtain individual transforms based upon the interpolation process. The interpolation of the transforms for each individual pixel or voxel will take into account rotation, scaling, translation and skew. The implementation may be based upon a multi-parameter transform approach, such as a 15-parameter mapping accounting for these four factors.

It has been found that the foregoing registration approach offers a number of advantages over existing techniques. For example, the initial rigid or affine process used for the whole-image or gross alignment uses regions that move by “initial guess” to begin the alignment search process, converging on best fits. Because the region-matching involves multiple pixels or voxels in a blob, it can generally locate a better fit with an error substantially less than the spacing of neighboring grid points in the fixed image, providing sub-pixel accuracy. Moreover, because each blob is relatively small compared to the entire moving image, as compared to most search methods, conversions to the best fit may be many times faster. Seeking to maximize mutual information may entail compilation of a joint histogram between values for matched blobs or regions. With a statistical approach to constructing the histogram by random samples, not every point in the moving image grid requires an estimated corresponding value, so that the numerical effort in whole-image mutual information matching does not grow proportionally with the number of points in the images. Reduction in the computational effort, then, reduces the need to move values in and out of memory cache. In currently available processors, such cache cannot typically hold the entire volume or area dataset for a typical image, but may be capable of holding intensity values for blobs, and a set of values from near the initial alignment in the fixed image. A whole three-dimensional volume image is often stored partially on disk rather than on high-speed memory, and conventional approaches defining virtual memory on a hard disk, while making the data exchange process relatively invisible to the programmer, creates thrashing as function calls access values randomly distributed over the dataset, so that different parts of the dataset must be reloaded into the physical memory. In the present technique, computational efficiency is enhanced by dividing the image into blobs of particular interest and of manageable size. Again, the data describing such blobs may be capable of loading into high-speed cache memory, along with a region around its initial representation with sufficient margin for local search.

The method disclosed above may be fully automated, choosing blobs purely on computed criteria. However, in many cases a user may not care equally about all parts of the images. For example, if a surgeon intends to operate in a particular region or anatomy of a patient, accurate matching there is critical, while in parts far from the procedure it is much less so. The present method adapts easily to user input in this respect. The contemplated implementation allows a user to select one or more “must be well matched” points or regions, and the system then chooses for each such point or region, the best blob (by the criteria described above) that contains the point or region.

It is also possible to allow the user to specify a number of corresponding pairs of points or regions, in the manner of choosing landmarks, but to use these not directly as input to an interpolation, but as starting conditions for a blob search. A blob containing each such point in the moving image may then be found, and the matching search begun with a local affine transformation that maps the point or region to the corresponding user-input point or region in the fixed image. The anatomical insight thus provided by the user ensures that the pairing is anatomically meaningful, but the user does not need to spend time and effort on the most exact matching pair possible (a slow and careful process, particularly in three-dimensional cases, where the user must often step back and forward through slices). Precision, at a better level than the user can input, is provided by the automatic blob matching process.

Similarly, if the global curvilinear matching found (by the interpolation above, by standard point-only algorithms, or by other means that exploit the output of the blob matching step) has visible problems or fails a global quality of match test numerically performed by the system, the user can intervene to add one or more corrective blobs.

In certain cases, the importance of particular locations can be detected automatically. In the example of PET imaging, the image extracted from the detectors is processed to yield two volume images in a shared coordinate framework with no need for registration. One image estimates the intensity of radiation emission at different points in space, and the other the absorption. The emission is normally highest in places of interest to the surgeon, such as radiatively labelled glucose preferentially absorbed by a fast growing tumor, so that a high emission value can be used to prioritize a region for blob choice. Other high intensity regions of less interest may occur, for reasons such as the body flushing a large amount of the injected material into the bladder. Because in the latter case the bladder is an anatomically meaningful landmark, including a blob there will generally have a geometrically constructive effect. In general, it may prove desirable to allow the user a menu of “hot spot” blobs from which to choose.

As another example, in cases for registration with CT images, it may be particularly useful to employ an absorption image for registration, as such images have a stronger relation with anatomical geometry. However, the present technique can use the emission data to contribute powerfully to the registration process, by contributing medically relevant priority values. Wherever features of special interest to the user can be correlated with a computable quantity, the method naturally exploits such knowledge.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for registering images comprising:
selecting candidate subregions in a moving image, the subregions comprising less than an entire image space of the moving image;
sub-selecting some or all of the subregions from the candidate subregions;
determining transforms for the selected subregions to similar subregions in a fixed image; and
interpolating the transforms for image data outside the transformed subregions.

2. The method of claim 1, wherein a predetermined pixel or voxel of each sub-selected subregion is transformed by a composite transform of the respective subregion, and other pixels or voxels of each sub-selected subregion are transformed by an individual transform derived from the composite transform of the respective subregion.

3. The method of claim 1, wherein the sub-region transforms interpolated include both rigid and non-rigid transforms.

4. The method of claim 1, comprising performing a global alignment of the moving and fixed images prior to selection of candidate subregions.

5. The method of claim 1, wherein the transforms are interpolated by at least one of multiple mechanisms including shape-weighted interpolation of deformation between the a centers of each subregion, tri-linear interpolation of a selected parameter, or weighted interpolation of neighboring transforms.

6. The method of claim 5, wherein the interpolation is performed based upon quaternion computations for rotation.

7. The method of claim 1, wherein the transforms are interpolated by application of a Delaunay triangulation.

8. The method of claim 1, wherein the subregions are non-contiguous.

9. The method of claim 1, wherein at least two of the subregions overlap with one another.

10. A method for registering images comprising:
selecting candidate subregions in a moving image, the subregions comprising less than an entire image space of the moving image;
sub-selecting fewer than all of the candidate subregions;
determining transforms for the sub-selected subregions to similar subregions in a fixed image, wherein a predetermined pixel or voxel of each sub-selected subregion is transformed by a composite transform of the respective subregion; and
interpolating the transforms for image data outside the transformed subregions, wherein each pixel or voxel around the predetermined pixel or voxel of each sub-selected subregion is transformed by an individual transform derived from the composite transform of the respective subregion.

11. The method of claim 10, wherein the sub-selection of the candidate subregions includes forcing selection of at least one candidate subregion of interest.

12. The method of claim 11, wherein the at least one candidate subregion of interest includes an anatomical feature of interest.

13. The method of claim 11, wherein the at least one candidate subregion is identified by operator input.

14. The method of claim 10, wherein the sub-region transforms interpolated include both rigid and non-rigid transforms.

15. The method of claim 10, comprising performing a global alignment of the moving and fixed images prior to selection of candidate subregions.

16. The method of claim 10, wherein the transforms are interpolated by at least one of multiple mechanisms including shaped-weighted interpolation of deformation at a predetermined location in each subregion, tri-linear interpolation of a selected parameter, or weighted interpolation of neighboring transforms.

17. A method for registering images comprising:
selecting candidate subregions in a moving image, the subregions comprising less than an entire image space of the moving image;
selecting some or all of the subregions from the candidate subregions;
determining transforms for the selected subregions to similar subregions in a fixed image; and
interpolating the transforms for image data outside the transformed subregions, wherein the sub-region transforms interpolated include both rigid and non-rigid transforms.

18. The method of claim 17, wherein a predetermined pixel or voxel of each sub-selected subregion is transformed by a composite transform of the respective subregion, and other pixels or voxels of each sub-selected subregion is transformed by an individual transform derived from the composite transform of the respective subregion.

19. A computer readable medium storing executable computer code for performing the steps set forth in claim 1.

20. A computer readable medium storing executable computer code for performing the steps set forth in claim 10.

21. A computer readable medium storing executable computer code for performing the steps set forth in claim 17.

22. A transformed image produced by the process steps set forth in claim 1.

23. A transformed image produced by the process steps set forth in claim 10.

24. A transformed image produced by the process steps set forth in claim 17.
